(19) United States
(12) Patent Application Publication
(10) Pub. No.: US 2011/0026659 A1
(43) Pub. Date: Feb. 3, 2011

(54) Control loop for a power plant

(75) Inventors: Tsung-Chieh Cheng, Longtan Township (TW); Yu-Chin Chi, Sinfong Township (TW); Ming-Huei Chen, Bade City (TW)

Correspondence Address: Jackson Intellectual Property Group PLLC, 106 Starvale Lane, Shipman, VA, 22971, US

(73) Assignee: ATOMIC ENERGY COUNCIL - INSTITUTE OF NUCLEAR ENERGY RESEARCH, Taoyuan (TW)

(21) Appl. No.: 12/076,260

(22) Filed: Mar. 14, 2008

(51) Int. Cl. G21C 7/32

(52) U.S. Cl. 376/210

(57) ABSTRACT

A control loop includes a pressure vessel, a condenser and a piping provided between the pressure vessel and the condenser. The piping includes a steam pipe for transferring dry air from the pressure vessel into the condenser, a turbine bypass pipe for transferring wet air from the pressure vessel into the condenser; a water-feeding pipe for transferring a first amount of water from the condenser into the pressure vessel and a pump bypass pipe for transferring a second amount of water from the condenser into the pressure vessel. Turbines are provided on the steam pipe and driven by the dry air. A turbine-controlling valve is provided on the steam pipe and operable to control the flow rate of the dry air. A turbine bypass valve is provided on the turbine bypass pipe and operable to control the flow rate of the wet air.

### BACKGROUND OF INVENTION

1. Field of Invention

The present invention relates to a power plant and, more particularly, to a control loop for a nuclear power plant.

2. Related Prior Art

Reactors used in nuclear power plants include boiling water reactors and pressurized water reactors. Nuclear power plants are complicated and big. It is not easy to achieve a well-coordinated operation in a nuclear power plant.

Digital control systems are used in fossil power plants and plants in the fossil industry. Most of the digital control systems are distributed control systems. The digital control systems cannot be used in nuclear power plants since the designs of nuclear power plants are conservative.

The present invention is therefore intended to obviate or at least alleviate the problems encountered in prior art.

### SUMMARY OF INVENTION

The primary objective of the present invention is to provide a control loop for a nuclear power plant.

To achieve the foregoing objective of the present invention, the control loop includes a pressure vessel, a condenser and a piping between the pressure vessel and the condenser. The piping includes a steam pipe for transferring dry air from the pressure vessel into the condenser, a turbine bypass pipe for transferring wet air from the pressure vessel into the condenser; a water-feeding pipe for transferring a first amount of water from the condenser into the pressure vessel and a pump bypass pipe for transferring a second amount of water from the condenser into the pressure vessel. Four turbines are provided on the steam pipe and driven by the dry air. A turbine-controlling valve is provided on the steam pipe and operable to control the flow rate of the dry air. A turbine bypass valve is provided on the turbine bypass pipe and operable to control the flow rate of the wet air. A water pump pumps the first amount of water from the condenser into the pressure vessel. A water-feeding valve is provided on the water-feeding pipe and operable to control the flow rate of the first amount of water. A pump bypass valve is provided on the pump bypass pipe and operable to control the flow rate of the second amount of water. An air-compressing system provides pressurized air into the pressure vessel. An inlet valve is operable to control the flow rate of the pressurized air from the air-compressing system into the pressure vessel. A makeup water system provides makeup water into the condenser. A makeup water valve is operable to control the flow rate of the makeup water. An air-dumping system dumps redundant air from the condenser. A water-dumping system dumps redundant water from the pressure vessel and the condenser.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a block diagram of a control loop for a nuclear power plant according to the preferred embodiment of the present invention.

FIG. 2 is a partial scheme of the control loop shown in FIG. 1.

FIG. 3 is a perspective view of a dryer used in the control loop shown in FIG. 1.

### DETAILED DESCRIPTION OF PREFERRED EMBODIMENT

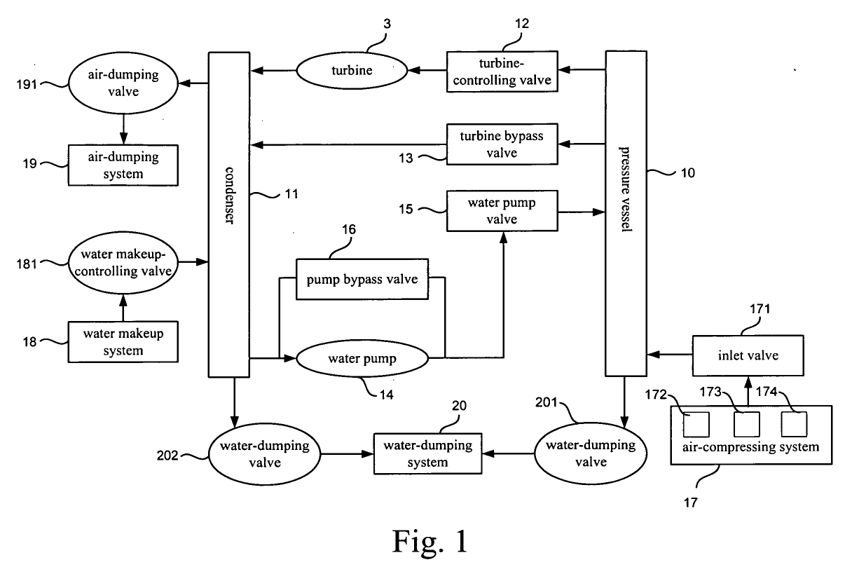

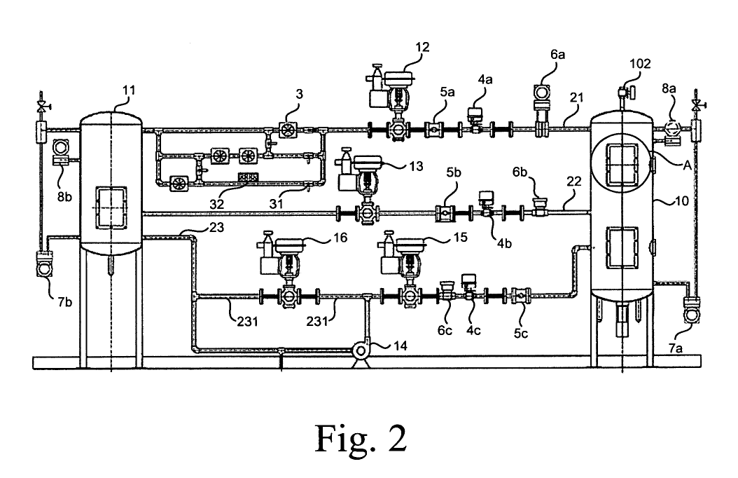

Referring to FIGS. 1 and 2, there is shown a control loop for a nuclear power plant according to the preferred embodiment of the present invention. The loop includes a pressure vessel 10, a condenser 11 and a piping between the pressure vessel 10 and the condenser 11. The piping includes a steam pipe 21, a turbine bypass pipe 22, a water-feeding pipe 23 and a pump bypass pipe 231. Each of the steam pipe 21, turbine bypass pipe 22, the water-feeding pipe 23 and the pump bypass pipe 231 includes at least one transparent section.

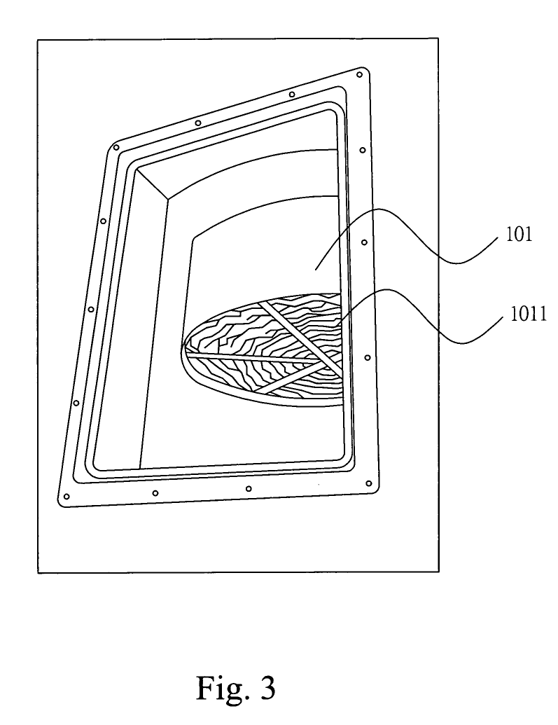

Referring to FIG. 3, the pressure vessel 10 includes a dryer 101 disposed therein. The dryer 101 includes a container and a corrugated board 1011 movably disposed in the container. An automatic release valve 102 is provided on the pressure vessel 10. Should the pressure in the pressure vessel 10 reach a predetermined value, the automatic release valve 102 would automatically release air from the pressure vessel 10, thus avoiding an excessively high value of the pressure in the pressure vessel 10.

The steam pipe 21 connects the pressure vessel 10 to the condenser 11. A flow rate transmitter 6a, an isolating valve 4a, a check valve 5a and a turbine-controlling valve 12 are arranged on the steam pipe 21. The steam pipe 21 includes three branches. Four turbines 3, five manual valves 31 and a generator 32 are provided on the branches of the steam pipe 21.

The turbine bypass pipe 22 connects the pressure vessel 10 to the condenser 11. A flow rate transmitter 6b, an isolating valve 4b, a check valve 5b and a turbine bypass valve 13 are provided on the turbine bypass pipe 22.

The water-feeding pipe 23 connects the condenser 11 to the pressure vessel 10. A water pump 14, a water pump valve 15, a flow rate transmitter 6c, an isolating valve 4c and a check valve 5c are provided on the water-feeding pipe 23.

The pump bypass pipe 231 is connected to the water-feeding pipe 23 at two points. A pump bypass valve 16 is provided on the pump bypass pipe 231.

An air-compressing system 17 is connected to the pressure vessel 10 through an inlet valve 171. The air-compressing system 17 includes an air dryer 172, an air compressor 173 and an air vessel 174.

A water level transmitter 7a and a pressure transmitter 8a are connected to the pressure vessel 10.

A water makeup system 18 is connected to the condenser 11 through a water makeup-controlling valve 181.

An air-dumping system 19 is connected to the condenser 11 through an air-dumping valve 191.

A water-dumping system 20 is connected to the pressure vessel 10 through a water-dumping valve 201. The water-dumping system 20 is connected to the pressure vessel 10 through a water-dumping valve 202.

A water level transmitter 7b and a pressure transmitter 8b are connected to the condenser 11.

The water level transmitter 7a, the pressure transmitter 8a, the flow rate transmitters 6a, 6b and 6c, the inlet valve 171, the water level transmitter 7b, the pressure transmitter 8b, the water makeup-controlling valve 181 and the air-dumping valve 191 are under the control of a distributed control system (“DCS”). The power of the pressure vessel 10, the operation of the turbines 3, the pressure, the feeding of the water, the operation of the condenser 11 and the emergency procedure are under the control of the DCS.

Firstly, the air dryer 172 and the air compressor 173 automatically accumulate air so that the pressure of the air reaches a nominal value. Then, the air compressor 173 transfers the air into the air vessel 174. Based on the power of the pressure vessel 10, the degree of the opening of the inlet valve 171 is controlled to allow the air to travel into the pressure vessel 10 from the air vessel 174.

On the other hand, water is provided into the pressure vessel 10 in a manner to be described later.

The corrugated board 1011 divides the air into wet air and dry air in the dryer 101 of the pressure vessel 10. The pressure is higher in the pressure vessel 10 than in the condenser 11, thus causing the dry air and the wet air to travel from the pressure vessel 10 into the condenser 11.

In and along the steam pipe 21, the dry air travels through the turbine-controlling valve 12. The degree of the opening of the turbine-controlling valve 12 is under control so that the flow rate of the dry air is under control. The manual valves 31 provided on the branches of the steam pipe 21 are operated to control the flow rates of currents of the dry air past the turbines 3, thus controlling the power at which the generator 32 generates electricity.

In and along the turbine bypass pipe 22, the wet air travels through the turbine bypass valve 13. Based on the pressure, the turbines 3 control the degree of the opening of the turbine bypass valve 13, thus controlling the flow rate of the wet air through the turbine bypass valve 13.

The amount of the dry air plus the amount of the wet air collected in the condenser 11 is the amount of steam. Hence, the turbine-controlling valve 12 and the turbine bypass valve 13 can be adjusted to control the flow rate of the steam. The pressure vessel 10 can be sealed by the isolating valve 4a and the check valve 5a provided on the steam pipe 21 and the isolating valve 4b and the check valve 5b provided on the turbine bypass pipe 22.

The condenser 11 collects the dry air past the turbines 3 and the wet air. Furthermore, the condenser 11 may receive water from the water makeup system 18 through the water makeup valve 181. The water pump 14 makes a major portion of the water flow into the water pump valve 15 from the condenser 11 through the water-feeding pipe 23. A minor portion of the water travels into the water pump valve 15 from the condenser 11 through the pump bypass pipe 231. Then, the water flows into the pressure vessel 10 under the control of the water pump valve 15. The water pump valve 15 is operated to control the flow rate of the water so that the water level reaches a predetermined level.

Redundant dry air travels from the condenser 11 into the air-dumping system 19 via the air-dumping valve 191 that is operable to control the flow rate of the redundant dry air.

A first amount of redundant water flows from the condenser 11 into the water-dumping system 20 via the water-dumping valve 202 operable to control the flow rate of the first amount of redundant water. A second amount of redundant water flows from the pressure vessel 10 into the water-dumping system 20 through the water-dumping valve 201 operable to control the flow rate of the second amount of redundant water.

As discussed above, the present invention relates to a control loop that improves conventional control loops. Configured is a relation between a digital control system and components, thus illustrating the basics of the operation of a nuclear power plant. Moreover, the DCS automatically controls the entire plant, updates the systems, collects information about the design of future nuclear power plants and cleans the environment.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A control loop comprising:
a pressure vessel;
a condenser;
a steam pipe for transferring dry air from the pressure vessel into the condenser;
four turbines provided on the steam pipe and driven by the dry air;
a turbine-controlling valve provided on the steam pipe and operable to control the flow rate of the dry air;
a turbine bypass pipe for transferring wet air from the pressure vessel into the condenser;
a turbine bypass valve provided on the turbine bypass pipe and operable to control the flow rate of the wet air;
a water-feeding pipe for transferring a first amount of water from the condenser into the pressure vessel;
a water pump for pumping the first amount of water from the condenser into the pressure vessel;
a water-feeding valve provided on the water-feeding pipe and operable to control the flow rate of the first amount of water;
a pump bypass pipe for transferring a second amount of water from the condenser to the pressure vessel;
a pump bypass valve provided on the pump bypass pipe and operable to control the flow rate of the second amount of water;
an air-compressing system for providing pressurized air into the pressure vessel;
an inlet valve operable to control the flow rate of the pressurized air from the air-compressing system into the pressure vessel;
a makeup water system for providing makeup water into the condenser;
a makeup water valve operable to control the flow rate of the makeup water;
an air-dumping system for dumping redundant air from the condenser; and
a water-dumping system for dumping redundant water from the pressure vessel and the condenser.

2. The control loop according to claim 1 comprising a water-dumping valve operable to control the flow rate of some of the redundant water from the pressure vessel into the water-dumping system.

3. The control loop according to claim 1 comprising a water-dumping valve operable to control the flow rate of some of the redundant water from the condenser into the water-dumping system.

4. The control loop according to claim 1 comprising an air-dumping valve operable to control the flow rate of the redundant air from the condenser into the air-dumping system.

5. The control loop according to claim 1 comprising an automatic release valve provided on the pressure vessel.

6. The control loop according to claim 1, wherein the pressure vessel comprises a dryer disposed therein and formed with a corrugated board for separating the dry air from the wet air.

7. The control loop according to claim 1, wherein the steam pipe comprises:
three branches on which the turbines are provided; and
manual valves provided on the branches and operable to control the flow rates of currents of the dry air past the turbines; and
a generator for generating electricity from the kinetic energy of the turbines.

8. The control loop according to claim 1 comprising an isolating valve and a check valve provided on the steam pipe.

9. The control loop according to claim 1 comprising an isolating valve and a check valve provided on the turbine bypass pipe.

10. The control loop according to claim 1 comprising an isolating valve and a check valve provided on the water-feeding pipe.

11. The control loop according to claim 1, wherein the air-compressing system comprises an air dryer, an air compressor and an air vessel.

12. The control loop according to claim 1 comprising a water level transmitter, a pressure transmitter and flow rate transmitters provided on each of the steam pipe and the turbine bypass pipe, wherein the water level transmitters, the pressure transmitters, the flow rate transmitters, the inlet valve, the air-dumping valve and the makeup water valve are under the control of a distributed control system so that the power of the pressure vessel, the operation of the turbines, the pressure, the feeding of the water, the operation of the condenser and the emergency procedure are under the control of the distributed control system.

13. The control loop according to claim 12, wherein the power of the pressure vessel is regulated via operating the inlet valve.

14. The control loop according to claim 12, wherein the operation of the turbines and the pressure are controlled via operating the turbine-controlling valve so that the dry air can travel past and drive the turbines while traveling from the pressure vessel into the condenser through the steam pipe because the pressure is higher in the pressure vessel than in the condenser.

15. The control loop according to claim 12, wherein the operation of the turbines and the pressure are controlled via operating the turbine bypass valve so that the wet air can travel from the pressure vessel into the condenser through the turbine bypass pipe because the pressure is higher in the pressure vessel than in the condenser.

16. The control loop according to claim 1 comprising an insolating valve provided on the water-feeding pipe.

17. The control loop according to claim 1, wherein each of the pipes comprises at least one transparent section.
